(19) United States
(12) Patent Application Publication
(10) Pub. No.: US 2009/0089269 A1
(43) Pub. Date: Apr. 2, 2009

(54) Method and system for managing information in a database

(76) Inventor: Jacqueline Linder, Menlo Park, CA (US)

Correspondence Address: Lester H. Bimbaum, 6 Oakmont Court, Simpsonville, SC, 29681, US

(21) Appl. No.: 11/906,514

(22) Filed: Oct. 2, 2007

(51) Int. Cl. G06F 17/30

(52) U.S. Cl. 707/4; 707/E17.008

(57) ABSTRACT

The present invention describes a method for managing information in a database. The method includes receiving a request from a first user in a first predefined format. The request includes a set of attributes. Further, the method includes extracting the set of attributes from the request. The method also includes searching for a first data set in the information present in the database based on the extracted set of attributes. The information in the database is organized in one or more categories. Furthermore, the method includes storing the request in the database under a first predetermined category. Moreover, the method includes receiving a response to the request from a second user in a second predefined format, with the response including the first data set. Additionally, the method includes updating the database based on the response.

### BACKGROUND OF THE INVENTION

The present invention relates in general to the field of information search, and more specifically, to a method and system for managing information in a database.

With the rapid growth of the Internet in recent years, it has become increasingly difficult for users to search and identify relevant information on the Internet. The Internet is a worldwide interconnection of computer networks that share and collate huge amounts of information in a collection of databases. This information can be in the form of web pages related to product specifications, price, contact details, user feedback, and the like. The large amount of information available makes it tedious for users to search for specific information on the Internet.

Search engines are available that assist users in searching for particular information. Search engines have spiders that crawl through the web pages on the Internet, based on keywords entered by users. The data is indexed through the use of algorithms employed in these search engines, and results matching the keywords are listed. However, these results may not be relevant for the particular information required by users. In addition, human intervention is involved since users need to spend extra time searching manually through a list of websites for the desired information from the results listed by the search engines.

Users can also search for the desired information through a search functionality associated with individual websites. The search functionality associated with the individual website can search for the desired information in its database and can provide the list of results that match the keywords entered by the users. The search functionality associated with the individual website can also search for the desired information in the databases of a collection of websites linked to the individual website by compiling data from this collection of websites. However, since the search for this information is performed only in the databases of specific websites, the search results may not be optimal.

Another way of searching for the desired information on the Internet is by the use of directories. Information available on the Internet is organized in the directories in the form of collections of Uniform Resource Locators (URLs). This information is organized in the directories in a hierarchical manner. Users can navigate through this hierarchy to locate the desired information. However, the number of levels in which the information can be organized and searched is limited. Moreover, since the directories refer to a particular web page on a website, the search may not be optimal and a manual search may be required to locate the desired information.

Moreover, since the search engines and directories organize information based on the Hypertext Transfer Protocol (HTTP) tags and URLs, and the like, an entity needs to maintain a website to get listed in the search results provided by these search engines and directories.

In light of the foregoing discussion, there is a need for a method and system for managing information in a database. The new method should require minimal manual searching to locate the desired information in the database. The new method should eliminate the need for an entity to maintain a website for users in order to learn about the entity.

### SUMMARY OF THE INVENTION

The present invention describes a method for managing information in a database. The method includes receiving a request from a first user in a first predefined format. The request includes a set of attributes. Further, the method includes extracting these set of attributes from the request. The method also includes searching for a first data set from the information in the database based on the extracted set of attributes. This information is organized in one or more categories. Thereafter, the method includes storing the request in the database under a first predetermined category. The method also includes receiving a response to the request from a second user in a second predefined format. The response includes the first data set. Furthermore, the method includes updating the database based on the response.

Thus, the present invention provides users with a method to accurately retrieve relevant information from a database. This information is intelligently and automatically organized into various categories. Entities such as businesses, organizations and individuals can add data under these categories present in the database, rather than creating/modifying their websites to upload data. This enables the business entities to promote their services to other users. Further, the process of searching in the database does not rely on HyperText Markup Language (HTML) tags or any special coding by the web developer. Users can receive meaningful results for their requests with minimal human intervention.

### BRIEF DESCRIPTION OF THE DRAWINGS

Before describing in detail the embodiments in accordance with the present invention, it should be observed that these embodiments reside primarily in a method and system for managing information in a database. Accordingly, the system components and method steps have been represented, where appropriate, by conventional symbols in the drawings, showing only those specific details that are pertinent for an understanding of the embodiments of the present invention, so as not to obscure the disclosure with details that will be readily apparent to those with ordinary skill in the art having the benefit of the description herein.

FIG. 1 illustrates an exemplary network where various embodiments of the present invention can be practiced;

FIG. 2 illustrates a block diagram of a server in accordance with an embodiment of the present invention;

FIG. 3 shows a flow diagram illustrating a method for managing information in a database in accordance with an embodiment of the present invention;

FIGS. 4 and 5 show a flow diagram illustrating a method for managing information in a database in accordance with another embodiment of the present invention; and

FIG. 6 shows a flow diagram illustrating a method for providing information to a user in accordance with yet another embodiment of the present invention.

### DETAILED DESCRIPTION OF THE INVENTION

While the various embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention as described in the claims.

An embodiment of the present invention describes a method for managing information in a database. The method includes receiving a request from a first user in a first predefined format. The request includes a set of attributes. Further, the method includes extracting the set of attributes from the request. The method also includes searching for a first data set from the information in the database based on the extracted set of attributes. The information in the database is organized in one or more categories. Moreover, the method includes storing the request in the database under a first predetermined category. The method also includes receiving a response to the request from a second user in a second predefined format. The response includes the first data set. Furthermore, the method includes updating the database based on the response.

Another embodiment of the present invention describes a method for providing information to a user. This information is managed in a database. The method includes receiving a request from a first user in a first predefined format. The request includes a set of attributes. Further, the method includes extracting the set of attributes from the request. The method also includes searching for a first data set from the information in the database based on the extracted set of attributes. The information in the database is organized in one or more categories. Moreover, the method includes storing the request in the database under a first predetermined category. The method also includes receiving a response to the request from a second user in a second predefined format. The response includes the first data set. Furthermore, the method includes updating the database based on the response of the second user in the first predetermined category. Thereafter, the method includes rendering the first data set to the first user in the second predefined format.

Another embodiment of the present invention provides a server. This server includes a transceiver that is configured to receive a request from a first user in a first predefined format. The request includes a set of attributes. The transceiver is configured to receive a response to the request from a second user in a second predefined format. The response received from the second user includes a first data set. The server also includes a database that is operatively coupled with the transceiver. The database is configured to organize information in one or more categories. This database is also configured to store the request under a first predetermined category. Further, the server includes a processor that is operatively coupled to the transceiver and the database. The processor is configured to extract the set of attributes from the request. Moreover, the processor is configured to search for the first data set from the information in the database based on the extracted set of attributes. Furthermore, the processor is configured to update the database based on the response.

Yet another embodiment of the present invention provides a computer program product for managing information in a database. The computer program product includes program instructions for receiving a request from a first user in a first predefined format. This request includes a set of attributes. Further, the computer program includes program instructions for extracting the set of attributes from the request. Moreover, the computer program product includes program instructions for searching for a first data set from the information in the database based on the extracted set of attributes. This information is organized in one or more categories. Furthermore, the computer program product includes program instructions for storing the request in the database under a first predetermined category. Additionally, the computer program product includes program instructions for receiving a response to the request from a second user in a second predefined format. The response includes the first data set. Moreover, the computer program product includes program instructions for updating the database based on the response.

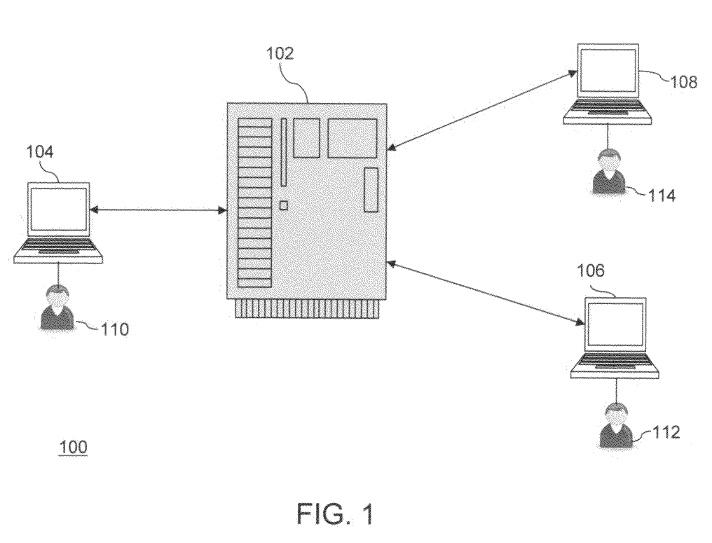

FIG. 1 illustrates an exemplary network 100, where various embodiments of the present invention can be practiced. Examples of the network 100 include, but are not limited to, the Internet, a wired or wireless Local Area Network (LAN), a Metropolitan Area Network (MAN), a Virtual Private Network (VPN), and a Wide Area Network (WAN). The network 100 includes a server 102. Examples of the server 102 include Hyper Text Transfer Protocol (HTTP) servers, File Transfer Protocol (FTP) servers, and the like.

The network 100 also includes a data processing unit 104, a data processing unit 106 and a data processing unit 108. Examples of the data processing units 104, 106 and 108 include desktop computers, laptop computers, palmtops®, mobile phones, Personal Digital Assistants (PDAs), and the like. The server 102 is connected to the data processing units 104, 106 and 108 through communication paths. These communication paths can be wired communication links or wireless communication links. Examples of wired communication links include optical fiber links, Ethernet cable links, and the like. Examples of wireless links include the Bluetooth® link, infrared links, satellite communications links, radio frequency links, and the like.

The network 100 also includes a user 110, a user 112 and a user 114. The users 110, 112 and 114 are associated with the data processing units 104, 106 and 108, respectively. The users 110, 112 and 114 can access the server 102 through the data processing units 104, 106 and 108, respectively. For example, the user 110 can send a request to the server 102 through the data processing unit 104. The request can pertain to searching for information, for example, searching a list of engineering students in Florida who like internet surfing. The server 102 processes the request by searching for the information in a database associated with the server 102. When this information is available in the database, the list of engineering students who like internet surfing is provided by the server 102 to the user 110 through the data processing unit 104. Although FIG. 1 is shown to include only the data processing units 104, 106 and 108, it will be apparent to a person of ordinary skill in the art that the network 100 can include a fewer or greater number of data processing units. Further, it will be apparent to a person of ordinary skill in the art that the network 100 can include a fewer or greater number of users than shown in FIG. 1.

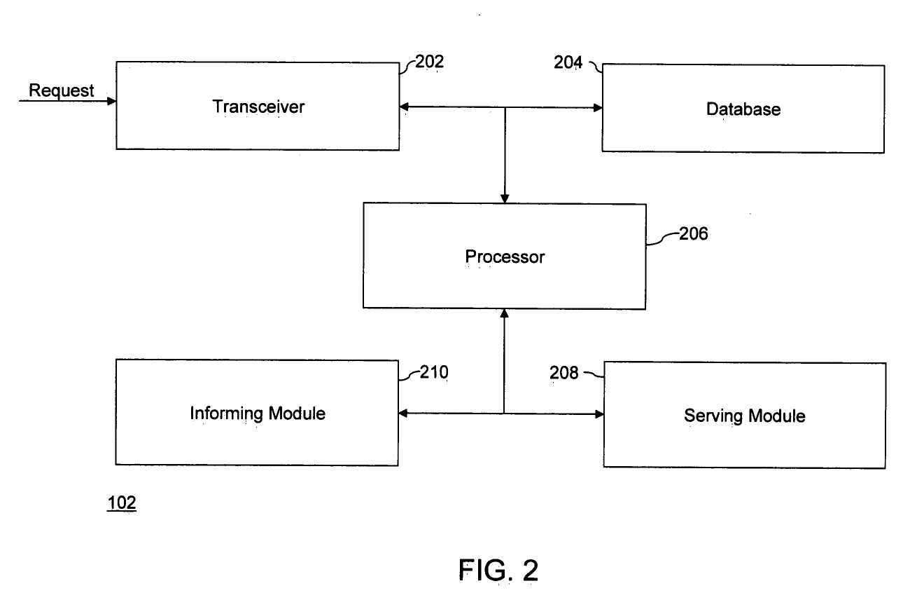

FIG. 2 illustrates a block diagram of the server 102, in accordance with an embodiment of the present invention. Those of ordinary skill in the art will understand that the server 102 may include additional components that are not shown here and are not pertinent to the operation of the server 102 in accordance with the inventive arrangements.

The server 102 includes a transceiver 202, a database 204 and a processor 206. The transceiver 202 is configured to receive a request from a first user, for example, the user 110. The request is received from the user 110 to search for a first data set, which is the data required by the user 110. For example, the transceiver 202 can receive a request from the user 110 to search for ‘an acupuncturist in Miami who is good at curing asthma’. Here, the first data set can refer to a list of acupuncturists in Miami who are good at curing asthma. Further, the request is received by the transceiver 202 in a first predefined format, for example, in a format such as ‘Do you know an acupuncturist in Miami who is good at curing asthma?’ This request received by the transceiver 202 is associated with various defining terms that qualify the request. The various defining terms correspond to a set of attributes. For example, ‘an acupuncturist in Miami’ and ‘good at curing asthma’ is the set of attributes that qualify the request.

The transceiver 202 is also configured to receive a response from a second user, for example, the user 114, in a second predefined format. For example, the second user can respond to a request placed by the first user on an online forum, when the second user visits the online forum. The response provided by the second user can be a solution to the request placed by the first user. The response received by the transceiver 202 is based on the request from the user 110. For example, the transceiver 202 receives a list of acupuncturists in Miami who are good at curing asthma from the user 114 based on the request of the user 110.

In an embodiment, the transceiver 202 is configured to receive a request from a third user, for example, the user 112, in a third predefined format. The request pertains to adding a second data set to the database 204, the second data set being the data provided by the user 112. However, the second data set is independent of the request made by the user 110. For example, the transceiver 202 can receive a list of Spanish translators who have specialization in Economics. This list is independent of the request received from the user 110.

The transceiver 202 is operatively coupled with the database 204. The database 204 can include information such as contact details, company profiles, news articles, product specifications, and the like. The information in the database 204 is organized in one or more categories. The users 110, 112 and 114 can create the one or more categories in the database 204.

The database 204 is configured to store the request received from the user 110. This request is classified under a first predetermined category of the one or more categories. The first predetermined category under which the request is classified is related to the set of attributes extracted from the request. For example, when a request is received for searching an acupuncturist in Miami who is good at curing asthma, the request is classified under the category related to the set of attributes ‘acupuncturist in Miami’ and ‘good at curing asthma’. That is, the request can be classified under any one of the categories ‘acupuncturists in Miami’ and ‘acupuncturists good at curing asthma’. In an embodiment, the request can be classified under the category ‘acupuncturists in Miami who are good at curing asthma’. The request is then stored in the first predetermined category. The first predetermined category can be any one of the categories ‘acupuncturists in Miami’, ‘acupuncturists good at curing asthma’ and ‘acupuncturists in Miami who are good at curing asthma’. The database 204 is also configured to store the first data set received from the user 114. The first data set is stored in the database 204 under the first predetermined category.

In an embodiment, the database 204 can include a variety of predefined formats. Examples of the plurality of predefined formats include ‘Do you know a (n) ______ who/where/that ______?’, ‘Where can I find a ______ who/where/that ______?’, ‘How do I ______?’, and ‘Is it possible to ______ with a ______?’, and the like.

The request to search for information stored in the database 204 is processed by the processor 206. The processor 206 is configured to extract the set of attributes from the request. For example, when a request is received by the transceiver 202 to search for an acupuncturist in Miami who is good at curing asthma, the processor 206 extracts attributes, such as, ‘acupuncturist in Miami’ and ‘good at curing asthma’, from the request.

In an embodiment, the processor 206 can also extract the first data set from the response provided by the user 114. For example, the processor 206 extracts a list of acupuncturists in Miami who are good at curing asthma, which is provided by the user 114. This response provided by the user 114 is based on the request received from the user 110.

The processor 206 is also configured to search for the first data set in the database 204. The first data set is searched for in the database 204 based on the extracted set of attributes. For example, when a request is received to search for an acupuncturist in Miami who is good at curing asthma, the processor 206 searches the database 204 based on the attributes, ‘acupuncturist in Miami’ and ‘good at curing asthma’.

In an embodiment, the processor 206 can assign the set of attributes extracted from the request to the first data set received from the user 114. For example, when the user 114 provides a list of the acupuncturists in Miami who are good at curing asthma, the processor 206 assigns the attributes ‘acupuncturist in Miami’ and ‘good at curing asthma’ to the list of acupuncturists provided by the user 114.

In another embodiment, the processor 206 can correlate the first data set to the first predetermined category. The correlation is performed after extracting the first data set from the response received by the user 114. For example, when a list of acupuncturists in Miami who are good at curing asthma is received from the user 114, the processor 206 extracts the list of acupuncturists from the response and then correlates the list with the category related to the set of attributes ‘acupuncturist in Miami’ and ‘good at curing asthma’ present in the database 204.

The processor 206 is also configured to determine whether the first data set is available in the database 204. Further, the processor 206 is configured to update the database 204, based on the response of the user 114. The database is updated to provide data to subsequent users.

In an embodiment, the server 102 includes a serving module 208, which is operatively coupled with the processor 206. The serving module 208 is configured to provide the first data set to the user 110. The first data set is provided by the serving module 208 in a predefined format. The serving module 208 provides the first data set to the user 110 when the first data set is available in the database 204. The serving module 208 can also provide the first data set to the user 110, based on the response of the user 114.

In another embodiment, the server 102 includes an informing module 210, which is configured to inform the user 110 about the availability of the first data set in the database 204. Examples of informing the user 110 include an email alert, a Short Messaging Service (SMS) alert, a messenger alert, a courier alert, and the like.

In an embodiment, the informing module 210 informs the user 110 about the availability of the first data set when the database 204 is updated, based on the response of the user 114.

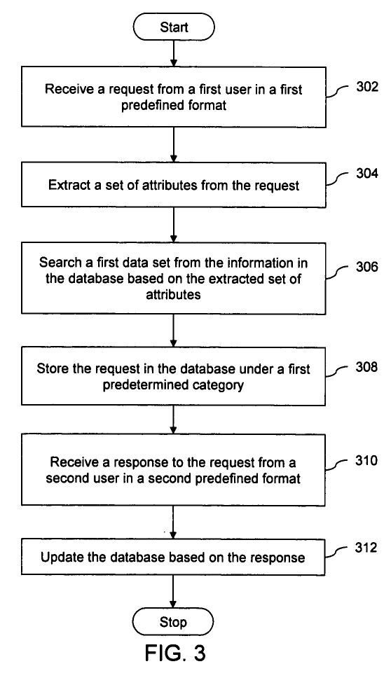

FIG. 3 shows a flow diagram illustrating a method for managing information in a database in accordance with an embodiment of the present invention. To describe the method, reference will be made to FIGS. 1 and 2, although it should be understood that the method can be implemented with reference to any other suitable embodiment of the present invention.

At step 302, a request is received by the server 102. This request is generated by a first user, for example, the user 110. The request pertains to searching for the first data set in the database associated with the server 102. For example, the user 110 can send a request to the server 102 to search for a hairdresser who specializes in curly hair and can speak Spanish. Here, the first data set can refer to a list of Spanish speaking hairdressers who specialize in curly hair. The request is received by the server 102 in the first predefined format, for example, ‘Do you know a hairdresser who specializes in curly hair and can speak Spanish?’ The request includes a set of attributes. For example, ‘hairdresser’ and ‘specializes in curly hair and can speak Spanish’ are the set of attributes included in the request.

At step 304, the set of attributes are extracted from the request by the server 102. The extracted set of attributes is used to search for the first data set in the database associated with the server 102. At step 306, the first data set is searched by the server 102 from the information in the database. This search is performed based on the extracted set of attributes. For example, the server 102 searches for the hairdresser, based on a set of attributes that include ‘hairdresser’ and ‘specializes in curly hair and can speak Spanish’. The information present in the database is organized in one or more categories. The first data set is searched in the one or more categories present in the database associated with the server 102.

At step 308, the request is stored by the server 102 in the database associated with server 102. This request is stored under the first predetermined category related to the set of attributes. For example, the server 102 stores a request for searching a hairdresser who specializes in curly hair and can speak Spanish, under a category related to the set of attributes, ‘hairdresser’ and ‘specializes in curly hair and can speak Spanish’, in the database. That is, the request can be classified under one of the categories ‘hairdressers’ and ‘specializing in curly hair and can speak Spanish’. In an embodiment, the request can be classified under the category ‘hairdressers specializing in curly hair and speaking Spanish’. The request is then stored in the first predetermined category. The first predetermined category can be any one of the categories ‘hairdressers’, ‘specializing in curly hair and can speak Spanish’ and ‘hairdressers specializing in curly hair and speaking Spanish’.

At step 310, the server 102 receives a response to the request from a second user, for example, the user 114. This response is in the second predetermined format and contains the first data set. For example, the user 114 can respond to the request made by the user 110 by providing a list of Spanish-speaking hairdressers who specialize in curly hair.

Thereafter, the database associated with the server 102 is updated at step 312, based on the response, by storing the first data set in the first predetermined category. For example, when the server 102 receives a list of Spanish-speaking hairdressers who specialize in curly hair, it updates the database by storing the list of hairdressers under the category related to the set of attributes ‘hairdresser’ and ‘specializes in curly hair and can speak Spanish’.

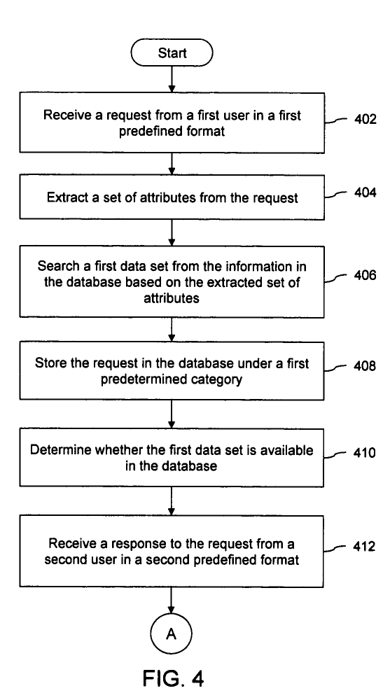

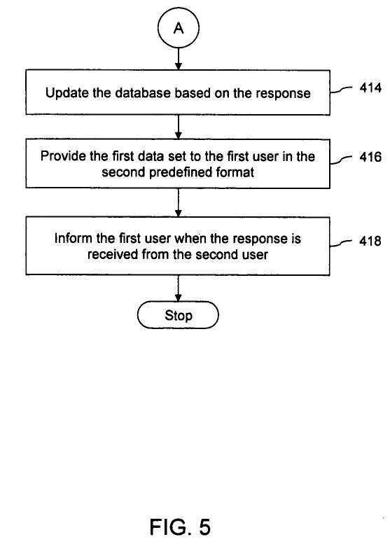

FIGS. 4 and 5 show a flow diagram illustrating a method for managing information in a database in accordance with an embodiment of the present invention. To describe the method, reference is made to FIGS. 1 and 2, although it should be understood that the method can be implemented with any other suitable embodiment of the present invention. Further, the method can contain a greater or fewer numbers of steps than shown in FIGS. 4 and 5.

At step 402, a request is received by the transceiver 202. This request is generated by the user 110 and pertains to searching for the first data set in the database 204. For example, the user 110 can send a request to the transceiver 202, to search for ‘a song that is good for a first dance at a wedding’. Here, the first data set can refer to the list of songs that are good for the first dance at the wedding. The request is received in the first predefined format, for example, ‘Do you know a song that is good for a first dance at a wedding?’ and includes a set of attributes. In conjunction with the example given above, ‘song’ and ‘good for a first dance at a wedding’ are the set of attributes of the request.

At step 404, the processor 206 extracts the set of attributes from the request. For example, when a request is generated to search for a song that is good for a first dance at a wedding, a set of attributes, such as ‘song’ and ‘good for a first dance at a wedding’, are extracted from the request. The extracted set of attributes is used to search for the first data set in the database 204.

At step 406, the processor 206 searches for the first data set from the information contained in the database 204. This search is performed based on the extracted set of attributes. The information present in the database 204 is organized in one or more categories. The first data set is searched by correlating the extracted set of attributes to the one or more categories. For example, the set of attributes, ‘song’ and ‘good for a first dance at a wedding’, are respectively correlated with the one or more categories present in the database 204. These one or more categories can be any of the categories ‘songs’, ‘good for a first dance at a wedding’ and ‘songs that are good for a first dance at a wedding’. The correlation of the set of attributes to the one or more categories is executed by the processor 206.

At step 408, the request is stored in a first predetermined category in the database 204. For example, the server 102 stores a request for searching for ‘a song that is good for a first dance at a wedding’ under a first predetermined category related to the set of attributes ‘song’ and ‘good for a first dance at a wedding’ in the database 204. The first predetermined category can be any one of the categories ‘songs’, ‘good for a first dance at a wedding’ and ‘songs that are good for a first dance at a wedding’.

At step 410, the processor 206 determines whether the first data set is available in the database 204. The availability of the first data set is determined to provide the first data set to the user 110. In an embodiment, the serving module 208 provides the first data set to the user 110 when the first data set is available in the database 204. For example, the database 204 provides the list of songs that are good for a first dance at the wedding to the user 110 when the list of songs is available in the database 204. The first data set is provided to the user 110 in a second predefined format.

The response to the request of the user 110 can also be provided by the user 114. At step 412, the response is received by the transceiver 202 from the user 114. The response provided by the user 114 is based on the request. For example, the user 114 can provide a list of songs such as ‘Endless Love’ and ‘You Light up My Life’ as the songs that are good for the first dance at the wedding. The response provided by the user 114 is received by the transceiver 202 in the second predetermined format.

Since the response is received from the user 114, at step 414 the database 204 is updated by the processor 206 based on the response. The processor 206 extracts the first data set from the response of the user 114. The set of attributes associated with the request are then assigned by the processor 206 to the first data set extracted from the response received from the user 114. For example, when the user 114 provides a list of songs, such as, ‘Endless Love’ and ‘You Light Up My life’ as the songs that are good for a first dance at a wedding, then the processor 206 assigns the attributes ‘song’ and ‘good for a first dance at a wedding’ to these songs. Thereafter, the processor 206 correlates the first data set with the first predetermined category and stores the first data set in the database 204. The first data set is stored under a first predetermined category. For example, the list of songs ‘Endless Love’ and ‘You Light Up My Life’ is correlated with the categories related to the set of attributes ‘song’ and ‘good for a first dance at a wedding’ and, then stored in the categories. These one or more categories can be any of the categories ‘songs’, ‘good for a first dance at a wedding’ and ‘songs that are good for a first dance at a wedding’.

Thereafter, at step 416, the first data set is provided to the user 110 by the serving module 208 in the second predefined format. The first data set can be made available to the user 110 in the database 204. Further, at step 418, the user 110 is informed about the response to the request. The informing module 210 informs the user 110 about the first data set. For example, the user 110 is informed about the response through an email.

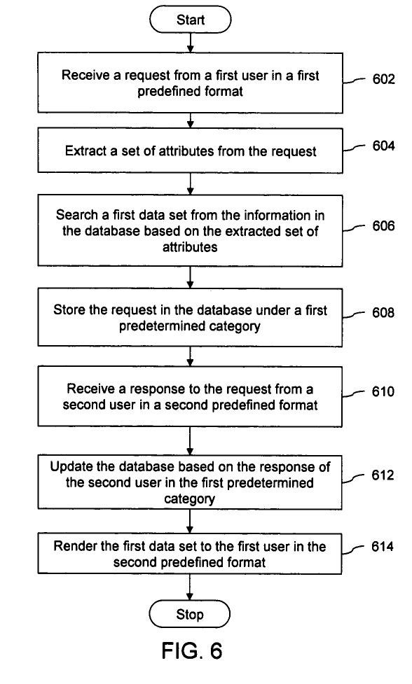

FIG. 6 shows a flow diagram illustrating a method for providing information to a user in accordance with yet another embodiment of the present invention. This information is managed in the database 204. To describe the method, reference will be made to FIGS. 1 and 2, although it should be understood that the method can be implemented with reference to any other suitable embodiment of the present invention.

At step 602, a request is received by the server 102. This request is generated by a first user, for example, the user 110. The request pertains to searching for the first data set in the database associated with the server 102. For example, the user 110 can send a request to the server 102 to search for private elementary schools in San Francisco that offer scholarships and have a summer program. A list of private elementary schools in San Francisco, offering scholarships and having a summer program, is the first data set. This request is received by the server 102 in the first predefined format, for example, ‘Do you know private elementary schools in San Francisco that offer scholarships and have a summer program?’ The request includes a set of attributes. For example, ‘private elementary schools in San Francisco’ and ‘offer scholarships and have a summer program’ are the set of attributes included in the request.

At step 604, the set of attributes are extracted from the request by the server 102. The extracted set of attributes is used to search for the first data set in the database associated with the server 102. Further, at step 606, the first data set is searched by the server 102 from the information in the database. This search is performed based on the extracted set of attributes. For example, the server 102 searches for private elementary schools in San Francisco that offer scholarships and have a summer program based on a set of attributes that includes ‘private elementary schools in San Francisco’ and ‘offer scholarships and have a summer program’. The information present in the database is organized in one or more categories. For example, the database can include categories such as ‘schools’, ‘scholarships’, ‘summer programs’ and the like. Hence, the private elementary schools in San Francisco that offer scholarships and have a summer program can be organized in the categories ‘schools’, ‘scholarships’ and ‘summer programs’ that are present in the database. The first data set is searched in the one or more categories present in the database associated with the server 102.

At step 608, the request is stored by the server 102 in the database associated with the server. This request is stored under a first predetermined category related to the set of attributes extracted from the request. For example, the server 102 stores a request for searching private elementary schools in San Francisco that offer scholarships and have a summer program under a category related to the set of attributes ‘private elementary schools in San Francisco’ and ‘offer scholarships and have a summer program’ in the database. The first predetermined category can be any one of the categories ‘private elementary schools in San Francisco’, ‘schools offering scholarships and having a summer program’ and ‘private elementary schools in San Francisco offering scholarships and having a summer program’.

At step 610, the server 102 receives a response to the request from a second user, for example, the user 114, in a second predetermined format. The response received from the user 114 contains the first data set. For example, the user 114 can respond to the request made by the user 110 by providing a list of private elementary schools in San Francisco that offer scholarships and have a summer program.

Thereafter, the database associated with the server 102 is updated at step 612, based on the response, by storing the first data set in the first predetermined category. For example, when the server 102 receives a list of private elementary schools in San Francisco that offer scholarships and have a summer program, it updates the database by storing the list of private elementary schools under the category related to the set of attributes ‘private elementary schools in San Francisco’ and ‘offer scholarships and have a summer program’.

Further, at step 614, the server 102 renders the first data set, in the second predefined format, to the user 110.

Thus, the present invention enables users to search for information on any topic in the database. Also, the present invention facilitates the organization of information related to a variety of topics in the database. The information present in the database builds up as users add information to the database in the form of answers to the questions posed by the users. Thus, the invention enables users to generate and share information through the database. Entities such as businesses, organizations and individuals can add data under these categories present in the database, rather than creating/modifying their websites to upload data. This enables these entities to promote their services to other users. Further, the process of searching in the database does not rely on html tags or any special coding by the web developer. Users can receive optimal results for their requests with minimal human intervention.

The method and system for managing information in a database, as described in the present invention, may be embodied in the form of a computer system. Typical examples of a computer system include a general-purpose computer, a programmed microprocessor, a micro-controller, a peripheral integrated circuit element, and other devices or arrangements of devices that are capable of implementing the steps constituting the method of the present invention.

The computer system comprises a computer, an input device, a display unit and the Internet. The computer comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive, an optical disk drive, and the like. Further, the storage device can be other similar means for loading computer programs or other instructions into the computer system.

The computer system executes a set of instructions that are stored in one or more storage elements, to process input data. The storage elements may also hold data or other information, as desired. The storage elements may be in the form of an information source or a physical memory element present in the processing machine. Exemplary storage elements include a hard disk, a DRAM, an SRAM and an EPROM. The storage elements may be external to the computer system and connected to or inserted into it, to be downloaded at or prior to the time of use. Examples of such external computer program products include computer-readable storage mediums such as CD-ROMS, flash chips, floppy disks, and the like.

The set of instructions may include various commands that instruct the processing machine to perform specific tasks such as the steps constituting the method of the present invention. The set of instructions may be in the form of a software program. The software may be in various forms such as system software or application software. Further, the software may be in the form of a collection of separate programs, a program module with a larger program, or a portion of a program module. The software may also include modular programming in the form of object-oriented programming. The software program containing the set of instructions can be embedded in a computer program product, for use with a computer; the computer program product comprising a computer-usable medium with a computer-readable program code embodied therein. Processing of input data by the processing machine may be in response to users' commands, to the results of previous processing, or to a request made by another processing machine.

The modules described herein may include processors and program instructions that implement the functions of the modules described herein. Some or all the functions can be implemented by a state machine that has no stored program instructions, or in one or more application-specific integrated circuits (ASICs), in which each function or some combinations of certain of the functions are implemented as custom logic.

While the various embodiments of the invention have been illustrated and described, it will be clear that the invention is not limited only to these embodiments. Numerous modifications, changes, variations, substitutions and equivalents will be apparent to those skilled in the art, without departing from the spirit and scope of the invention, as described in the claims.

What is claimed is:

1. A method for managing information in a database, the method comprising:
receiving a request from a first user in a first predefined format, wherein the request comprises a set of attributes;
extracting the set of attributes from the request;
searching a first data set from the information in the database based on the extracted set of attributes, wherein the information is organized in one or more categories;
storing the request in the database under a first predetermined category;
receiving a response for the request from a second user in a second predefined format, wherein the response comprises the first data set; and
updating the database based on the response.

2. The method as recited in claim 1 further comprising determining whether the first data set is available in the database.

3. The method as recited in claim 1 further comprising providing the first data set to the first user in the second predefined format when the first data set is available in the database.

4. The method as recited in claim 1 further comprising providing the first data set to the first user in the second predefined format when the database is updated.

5. The method as recited in claim 1, wherein searching comprises correlating the set of attributes to the one or more categories in the database.

6. The method as recited in claim 1, wherein updating comprises:
extracting the first data set from the response received from the second user;
assigning the set of attributes to the first data set when the response is received from the second user; and
correlating the first data set to the first predetermined category.

7. The method as recited in claim 1 further comprising receiving a request from a third user in a third predefined format for adding a second data set to the information present in the database.

8. The method as recited in claim 1 further comprising informing the first user when the response is received from the second user.

9. A method for providing information to a user, the information being managed in a database, the method comprising:
receiving a request from a first user in a first predefined format, wherein the request comprises a set of attributes;
extracting the set of attributes from the request;
searching a first data set from the information in the database based on the extracted set of attributes, wherein the information is organized in one or more categories;
storing the request in the database under a first predetermined category;
receiving a response for the request from a second user in a second predefined format, wherein the response comprises the first data set;
updating the database based on the response of the second user in the first predetermined category; and
rendering the first data set to the first user in the second predefined format.

10. The method as recited in claim 9 further comprising providing the first data set to the first user in the second predefined format when the first data set is available in the database.

11. The method as recited in claim 9 further comprising determining whether the first data set is available in the database.

12. The method as recited in claim 9, wherein searching comprises correlating the set of attributes to the one or more categories in the database.

13. The method as recited in claim 9, wherein updating comprises:
extracting the first data set from the response received from the second user;
assigning the set of attributes to the first data set when the response is received from the second user; and
correlating the first data set to the first predetermined category.

14. The method as recited in claim 9 further comprising receiving a request from a third user in a third predefined format for adding a second data set to the information present in the database.

15. The method as recited in claim 9 further comprising informing the first user when the response is received from the second user.

16. A server comprising:
a transceiver configured to:
receive a request from a first user in a first predefined format, wherein the request comprises a set of attributes; and
receive a response for the request from a second user in a second predefined format, wherein the response comprises a first data set;
a database configured to:
organize information in one or more categories; and
store the request under a first predetermined category; and
a processor configured to:
extract the set of attributes from the request;
search for the first data set from the information in the database based on the extracted set of attributes; and
update the database based on the response.

17. The server as recited in claim 16, wherein the processor is further configured to determine whether the first data set is available in the database.

18. The server as recited in claim 16 further comprising a serving module operatively coupled with the processor, wherein the serving module is configured to provide the first data set in the second predefined format to the first user.

19. The server as recited in claim 16, wherein the processor is further configured to extract the first data set from the response of the second user.

20. The server as recited in claim 16, wherein the processor is further configured to:
correlate the set of attributes to the one or more categories in the database;
assign the set of attributes to the first data set; and
correlate the first data set to the first predetermined category.

21. The server as recited in claim 16, wherein the transceiver is further configured to receive a request from a third user in a third predefined format for adding a second data set to the information present in the database.

22. The server as recited in claim 16 further comprises an informing module, wherein the informing module is configured to inform the first user when the response is received from the second user.

23. A computer program product for managing information in a database, the computer program product comprising a computer readable medium comprising:
program instructions for receiving a request from a first user in a first predefined format, wherein the request comprises a set of attributes;
program instructions for extracting the set of attributes from the request;
program instructions for searching a first data set from the information in the database based on the extracted set of attributes, wherein the information is organized in one or more categories;
program instructions for storing the request in the database under a first predetermined category;
program instructions for receiving a response for the request from a second user in a second predefined format, wherein the response comprises the first data set; and
program instructions for updating the database based on the response.

24. The computer program product as recited in claim 23 further comprising program instructions for determining whether the first data set is available in the database.

25. The computer program product as recited in claim 23 further comprising program instructions for providing the first data set to the first user in the second predefined format when the first data set is available in the database.
